(19) United States
(12) Patent Application Publication
(10) Pub. No.: US 2004/0025942 A1
(43) Pub. Date: Feb. 12, 2004

(54) Air breather for an automobile transmission

(76) Inventor: Woo-Yeol Kim, Kyungki-do (KR)

Correspondence Address: Pennie & Edmonds, LLP, 3300 Hillview Avenue, Palo Alto, CA, 94304, US

(21) Appl. No.: 10/310,326

(22) Filed: Dec. 4, 2002

(30) Foreign Application Priority Data
Aug. 8, 2002 (KR) 2002-46772

(51) Int. Cl. F16K 17/26

(52) U.S. Cl. 137/493

(57) ABSTRACT

The air breather is formed with a breather body coupled to a transmission body, and a cap coupled to an upper part of the breather body. The breather body defines first and second spaces communicating therebetween by an air channel. The first space is coupled with a first piston which slides to open and close the air channel in response to internal pressure applied to both lateral surfaces thereof. The second space is coupled with a second piston which slides in response to air having passed through the air channel and is further equipped with oil return holes for oil having passed through the air channel from the first space and having been separated to return into the first space, such that the oil and the air are effectively separated to prevent oil leakage.

### FIELD OF THE INVENTION

The present invention relates to an air breather for an automobile transmission, and more particularly, to an air breather adapted to effectively separate oil from air in an air/oil mixture in a transmission and to return same into the transmission, thereby preventing leakage of the oil.

### BACKGROUND OF THE INVENTION

Automobile transmissions typically include air breathers for discharging internal air to prevent internal pressure buildup. Such transmissions are filled with lubricating oil to avoid abrasion and damage of various transmission gears and transmission parts during operation.

In a typical air breather, a breather body is coupled to the transmission body. The breather body generally includes a cap for allowing air to slowly exhaust therethrough. The cap may be mounted over a rubber piston that is biased into place on an upper surface of the breather body by a spring. When pressure in the transmission is raised, the pressure within the breather body raises, thereby forcing the piston upward, allowing air to be discharged. Oil contained in the air impacts a bottom surface of the piston and is returned into the transmission.

However, in such air breathers, oil is not completely separated from the air and therefore the air breather allows some oil to leak out. There is thus a need for an air breather that more completely prevents oil leaks.

### SUMMARY OF THE INVENTION

The present invention provides an air breather for an automobile transmission adapted to separate oil from air, effectively preventing the oil in the transmission from being leaked. In one embodiment, a breather includes a breather body coupled to a transmission body, and a cap coupled to an upper part of the breather body. The breather body is preferably formed at an inner upper portion thereof with first and second spatial units communicating therebetween by an air channel. The first spatial unit is coupled with a first piston which slides to open and close the air channel in response to internal pressure applied to both lateral surfaces thereof, and the second spatial unit is coupled with a second piston which slides in response to air having passed the air channel and is further equipped with oil return holes for the oil having passed the air channel from the first spatial unit and having been separated to return into the first spatial unit.

The first piston is internally mounted in a cylinder fixedly inserted in the first spatial unit and is equipped at both sides thereof with first restoring springs to slideably support the first piston while the cylinder is formed at both sides thereof with through holes for allowing internal pressure of the transmission to simultaneously apply pressure to both sides of the first piston.

The second piston is slideably supported by a second restoring spring. The oil return holes are equipped with a cap which is opened and closed in response to the internal pressure of the transmission. Furthermore, the oil return holes are preferred to be respectively formed at both sides of the air channel.

According to another embodiment of the invention there is provided an air breather for an automobile transmission. The air breather comprises a cap, a first piston, a second piston and first and second restoring springs. The cap is configured to be coupled to a remote end of a breather body of a transmission. The cap defines a first space fluidly coupled to the breather body, a second space, an air channel fluidly coupling the first space to the second space, and at least one oil return hole for returning oil from the second space into the breather body. The first piston is slideably coupled to the cap within the first space. The first piston is configured to fluidly open and close the air channel when displaced in a first direction. The second piston is slideably coupled to the cap adjacent or within the second space. The second piston is configured to move in a second direction in response to pressure within the second space. In a preferred embodiment the second direction is substantially perpendicular to the first direction. Also in a preferred embodiment, the first direction is horizontal and the second direction is vertical. The first piston is coupled to the cap with at least one first restoring spring, while the second piston is slideably coupled to the cap via a second restoring spring. In a preferred embodiment, the first space is formed by a cylinder within the cap, where the cylinder defines two through holes on each side of the first piston for allowing internal pressure of the transmission to simultaneously apply pressure to both sides of the first piston. The oil return holes are preferably formed at both sides of the air channel and are coupled to lids which are opened and closed in response to the internal pressure of the transmission.

### BRIEF DESCRIPTION OF THE DRAWINGS

For fuller understanding of the nature and objects of the invention, reference should be made to the following detailed description taken in conjunction with the accompanying drawings in which:

FIG. 1 is a cross-sectional view of an air breather of an automobile transmission according to one embodiment of the present invention;

FIG. 2 is a cross-sectional view taken along line III-III of FIG. 1; and

FIG. 3 is a cross-sectional view taken along line IV-IV of FIG. 2.

### DETAILED DESCRIPTION OF THE INVENTION

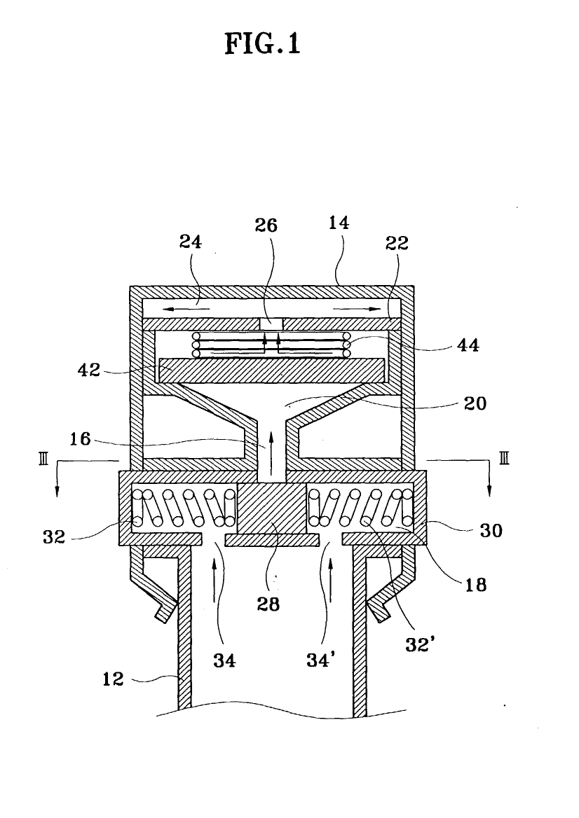

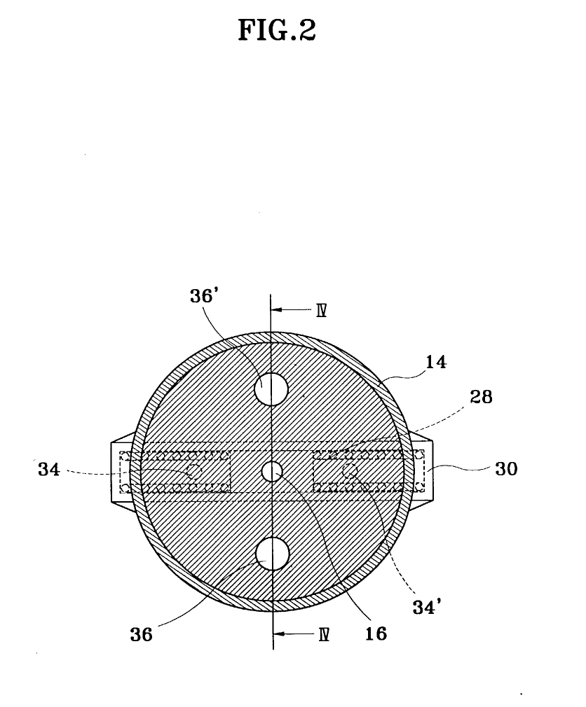

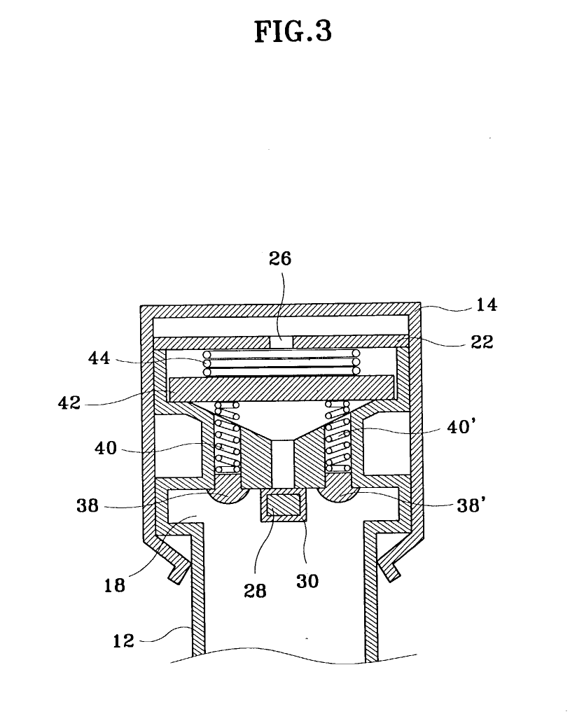

As illustrated in FIGS. 1, 2 and 3, a breather body 12 coupled to a transmission body (not shown) is formed with a cap 14 thereon for slow air exhaust to pass therethrough. An upper part of the breather body 12 defines an air channels 16 for communicating between a first space 18 and a second space 20. The first space 18 is formed underneath the air channel 16 while the second space 20 is formed above the air channel 16. The breather body 12 is blocked at an upper end thereof by a plate 22. A free space 24 is formed between the plate 22 and the cap 14. A hole 26 in the plate 22 allows air to pass from the second space 20 into the free space 24.

The air channel 16 is formed in a funnel shape. A first piston 28 is housed within the first space 18. The first piston 28 receives internal pressure from the transmission at both sides thereof to slide, and to open and close the air channel 16. The first piston 28 is mounted inside a cylinder 30 fixedly inserted within the first space 18. The first piston 28 is equipped at both sides thereof with first restoring springs 32 and 32′, which in turn support the first piston 28 for horizontal and slidable movement. The bottom of the cylinder 30 defines two through holes 34 and 34′ to allow the internal pressure of the transmission to press both sides of the first piston 28 at the same time.

The breather body 12 also defines oil holes 36 and 36′ on each side of the air channel 16. The oil return holes 36 and 36′ allow oil which has been separated by passing through the air channel 16 from the first space 18 to be returned the first space 18. Outlets of the oil return holes 36 and 36′ are fixedly coupled via springs 40 and 40′ with lids 38 and 38′, which are opened and closed in response to the internal pressure of the transmission. The springs 40 and 40′ are fixed at upper ends thereof to a bottom surface of a second piston 42.

The second space unit 20 houses the second piston 42, which slides vertically under the force of passing through the air channel 16. The second piston 42 is slideably supported by a second restoring spring 44, which in turn is mounted within a space between an upper surface of the plate 22 and the second piston 42.

During normal operation, the first piston 28 blocks the air channel 16 at a neutral position in response to a balanced movement of the left and right first restoring springs 32 and 32′. However, when pressure rises in the transmission, an oil/air mixture is introduced into the cylinder 30 through the left and right through holes 34 and 34′, thereby acting on both sides of the first piston 28. The oil/air mixture is not introduced into the cylinder 30 at a constant oil pressure, but rather as a foam, such that a pressure difference is produced at the left and right sides of the first piston 28 to instantly move the first piston 28 to the left or right side of the first piston 28, thereby moving the first piston 28 and allowing the oil/air mixture to rise through the air channel 16. At this time, pressure is lowered by the orifice effect of the air channel 16 thereby removing the foam and separating the oil from the air. The separated air forces the second piston 42 to rise through a gap formed between the second piston and the breather body. The air then passes through the hole 26 and is discharged through fine holes at the cap 14.

When an automobile is in motion, the lids 38 and 38′ are closed by the internal pressure, whereby the separated oil is gathered at the oil return holes 36 and 36′. However, when an automobile is not in motion, the pressure in the transmission is lowered, thereby opening the lids 38 and 38′ in response to the restoring force of the second restoring spring 44 and the oil collected at the oil return holes 36 and 36′ is returned to the first spatial unit 18 for infusion into the transmission.

As apparent from the foregoing, there is an advantage in the air breather for automobile transmission thus described according to the present invention in that air and oil are effectively separated to prevent oil leakage in the transmission.

What is claimed is:

1. An air breather for an automobile transmission, the breather formed with a breather body configured to be coupled to a transmission body, and a cap coupled to an upper part of said breather body, wherein said breather body is formed at an inner upper part thereof with first and second spatial units communicating therebetween by an air channel, where said first spatial unit is coupled with a first piston which slides to open and close said air channel in response to internal pressure applied to both lateral surfaces thereof, and said second spatial unit is coupled with a second piston which slides in response to air having passed through said air channel and is further equipped with oil return holes for the oil having passed through said air channel from said first spatial unit and having been separated to return into said first spatial unit.

2. The breather as defined in claim 1, wherein said first piston is internally mounted in a cylinder fixedly inserted in said first spatial unit and is equipped at both sides thereof with first restoring spring to slideably support said first piston while the cylinder is formed at both sides thereof with through holes for allowing internal pressure of the transmission to simultaneously apply pressure to both sides of said first piston.

3. The breather as defined in claim 1, wherein said second piston is slideably supported by a second restoring spring.

4. The breather as defined in claim 1, wherein said oil return holes are formed at both sides of said air channel.

5. The breather as defined in claim 1, wherein said oil return holes are coupled to lids which are opened and closed in response to the internal pressure of the transmission.

6. An air breather for an automobile transmission, comprising:
a breather body;
a cap coupled to a remote end of the breather body, said cap defining a first space fluidly communicating with said breather body, a second space, an air channel fluidly coupling said first space to said second space, and at least one oil return hole for returning oil from said second space into said breather body;
a first piston slideably coupled to said cap within said first space, where said first piston is configured to fluidly open and close said air channel when displaced in a first direction; and
a second piston slideably coupled to said cap adjacent said second space, where said second piston is configured to move in a second direction, substantially parallel to said first direction, in response to pressure within said second space.

7. The air breather as defined in claim 1, wherein said first piston is coupled to said cap with at least one first restoring spring.

8. The air breather as defined in claim 1, wherein said first space is formed by a cylinder within said cap, where said cylinder defines two through holes on each side of said first piston for allowing internal pressure of the transmission to simultaneously apply pressure to both sides of said first piston.

9. The breather as defined in claim 1, wherein said second piston is slideably coupled to said cap via a second restoring spring.

10. The breather as defined in claim 1, wherein said oil return holes are formed at both sides of said air channel.

11. The breather as defined in claim 1, wherein said oil return holes are coupled to lids which are opened and closed in response to the internal pressure of the transmission.
